(19) United States
(12) Patent Application Publication
(10) Pub. No.: US 2018/0226846 A1
(43) Pub. Date: Aug. 9, 2018

(54) STACKED IRON CORE FOR ARMATURE, AND ARMATURE

(71) Applicant: MITSUBISHI ELECTRIC CORPORATION, Chiyoda-ku, Tokyo (JP)

(72) Inventors: Hironori TSUIKI, Tokyo (JP); Sachiko KAWASAKI, Tokyo (JP); Akira HASHIMOTO, Tokyo (JP)

(73) Assignee: MITSUBISHI ELECTRIC CORPORATION, Chiyoda-ku, Tokyo (JP)

(21) Appl. No.: 15/504,511

(22) PCT Filed: Oct. 23, 2015
(86) PCT No.: PCT/JP2015/080009

§ 371 Date: Feb. 16, 2017

(30) Foreign Application Priority Data
Nov. 5, 2014 (JP) 2014-224917

(51) Int. Cl. H02K 1/16; H02K 3/12; H02K 3/34

(52) U.S. Cl. CPC H02K 1/165; H02K 3/345; H02K 3/12

(57) ABSTRACT

A stacked iron core for an armature includes: an annular iron core piece having first iron core piece tooth portions, and connecting portions each for connecting circumferential ends of an end portion on an inner circumference side of each of the first iron core piece tooth portions; and an iron core piece stacked between the first iron core piece tooth portions of two of the annular iron core pieces, the iron core piece including: a second iron core piece tooth portion having an identical shape to that of the first iron core piece tooth portion; and flange portions protruding to both sides in a circumferential direction from an inner-circumference-side end of the second iron core piece tooth portion, and the iron core piece is separated from the iron core piece adjacent thereto in the circumferential direction, the connecting portion has a width y that is constant in a radial direction.

### TECHNICAL FIELD

The present invention relates to a stacked iron core for armature and an armature that are used in a rotary electric machine.

### BACKGROUND ART

In recent years, rotary electric machines such as electric motors and electric generators are required to have high efficiency and to cause less vibration. As one method for realizing a rotary electric machine that causes less vibration, there is a method for narrowing the width of the slot opening of the stacked iron core of the armature. If the width of the slot opening is narrowed, it is possible to suppress vibration of the rotary electric machine using the armature, with salient poles thereof reduced.

However, if the ends of teeth adjacent to each other are located too close to each other, leakage flux that circulates in the stator not via the rotor increases, and the output of the rotary electric machine is reduced. With regard to this problem, in the invention according to Patent Document 1 , flange portions at the tooth ends of iron cores are connected to each other, salient poles of the armature are reduced by using inner-outer divided cores each obtained by dividing the tooth portion and the back yoke portion, and the width of the connecting portion is reduced, whereby magnetic resistance of the connecting portion is increased and leakage flux described above is reduced.

In the invention according to Patent Document 2, cores whose tooth ends are connected to each other are partially arranged, and teeth not connected to an adjacent tooth are provided, whereby leakage flux is reduced.

### CITATION LIST

### Patent Document

Patent Document 1: Japanese Laid-Open Patent Publication No. 2003-88007

Patent Document 2: Japanese National Phase PCT Laid-Open Publication No. 2005-516574

### SUMMARY OF THE INVENTION

### Problems to be Solved by the Invention

However, the stacked iron core according to Patent Document 1 additionally has a step of pressing, into a thin shape, a part of the iron core piece forming the stacked iron core. Thus, when the part is pressed, the iron core piece is extended in the circumferential direction. This causes a problem of enlarged diameter of the inner-side stacked iron core and a shifted pitch in the circumferential direction of the teeth. In the stacked iron core according to Patent Document 2, the slit provided in the connecting portion diagonally to the axial direction makes the connecting portion thin. This causes a problem of occurrence of deformation of the stacked iron core or breakage of the connecting portion during insertion of the coil or during handling.

The present invention has been made in order to solve the problems as described above. An object of the present invention is to provide a stacked iron core for armature and an armature that can reduce leakage flux that circulates from the end of a tooth to an adjacent tooth, and that can suppress vibration of the rotary electric machine.

### Solution to the Problems

A stacked iron core for armature according to the present invention includes:

an outer-side iron core as an annular yoke portion; and

an inner-side stacked iron core having a plurality of stacked teeth fitted in fitting portions provided at an inner circumferential surface of the annular yoke portion, the fitting portions being arranged at equal intervals and extending in an axial direction, the plurality of stacked teeth protruding from the fitting portions to an inner side in a radial direction, wherein

the inner-side stacked iron core includes:
an annular iron core piece having first iron core piece tooth portions, and connecting portions each for connecting, in a ring shape in a circumferential direction, circumferential both ends of an end portion on an inner circumference side of each of adjacent first iron core piece tooth portions; and
an iron core piece stacked between the first iron core piece tooth portions of two of the annular iron core pieces, the iron core piece including: a second iron core piece tooth portion having an identical shape to that of the first iron core piece tooth portion; and flange portions protruding to both sides in a circumferential direction from an inner-circumference-side end of the second iron core piece tooth portion,

the iron core piece is separated from the iron core piece adjacent thereto in the circumferential direction,

the connecting portion has a width y that is constant in the radial direction,

a root portion of the flange portion has the width y in the radial direction, and

an end portion of the flange portion has a width x smaller than y.

An armature according to the present invention includes a plurality of coils having insulation coating in slots formed between the inner circumferential surface of the outer-side iron core and adjacent stacked teeth of the inner-side stacked iron core.

### Effect of the Invention

According to the stacked iron core for armature and the armature of the present invention, the width in the radial direction of the connecting portion between adjacent teeth can be made large and constant for the entire circumference of the annular iron core piece. Thus, the rigidity of the connecting portion is increased and deformation of the core during insertion of the coil or during handling can be suppressed.

In addition, the flange portion of each tooth protruding in the circumferential direction from the iron core piece tooth portion not connected to an adjacent iron core piece tooth portion is made thin toward the end portion thereof in the circumferential direction, whereby it is possible to provide a high performance stacked iron core for armature and a high performance armature that can suppress leakage flux circulating between adjacent stacked teeth.

### BRIEF DESCRIPTION OF THE DRAWINGS

FIG. 1 is a perspective view of an armature according to embodiment 1 of the present invention.

FIG. 2 is a perspective view of a stacked iron core of the armature according to embodiment 1 of the present invention.

FIG. 3 is perspective views of an inner-side stacked iron core of the armature according to embodiment 1 of the present invention.

FIG. 4 is plan views of iron core pieces forming the same stack-layer in the inner-side stacked iron core of the armature according to embodiment 1 of the present invention.

FIG. 5 is enlarged plan views showing a major part of the inner-side stacked iron core of the armature according to embodiment 1 of the present invention.

FIG. 6 is a perspective view of an outer-side iron core of the armature according to embodiment 1 of the present invention.

FIG. 7 is a perspective view illustrating an iron core fitting step for the armature according to embodiment 1 of the present invention.

FIG. 8 is a cross-sectional view of a major part of the armature according to embodiment 1 of the present invention.

FIG. 9 is a modification of a flange portion of the iron core piece according to embodiment 1 of the present invention.

FIG. 10 is a modification of the flange portion of the iron core piece according to embodiment 1 of the present invention.

FIG. 11 is a perspective view of an inner-side stacked iron core of the armature according to embodiment 2 of the present invention.

FIG. 12 is an enlarged plan view of a major part of the inner-side stacked iron core of the armature according to embodiment 2 of the present invention.

FIG. 13 is perspective views of an inner-side stacked iron core of the armature according to embodiment 3 of the present invention.

FIG. 14 is plan views of iron core pieces forming the same stack-layer in the inner-side stacked iron core of the armature according to embodiment 3 of the present invention.

### DESCRIPTION OF EMBODIMENTS

### Embodiment 1

Hereinafter, a stacked iron core for armature and an armature according to embodiment 1 of the present invention will be described with reference to the drawings. Herein, “circumferential direction”, “radial direction”, “axial direction”, “inner side”, “outer side”, “inner circumference”, and “outer circumference” respectively refer to “circumferential direction”, “radial direction”, “axial direction”, “inner side”, “outer side”, “inner circumference” and “outer circumference” of the armature of a rotary electric machine.

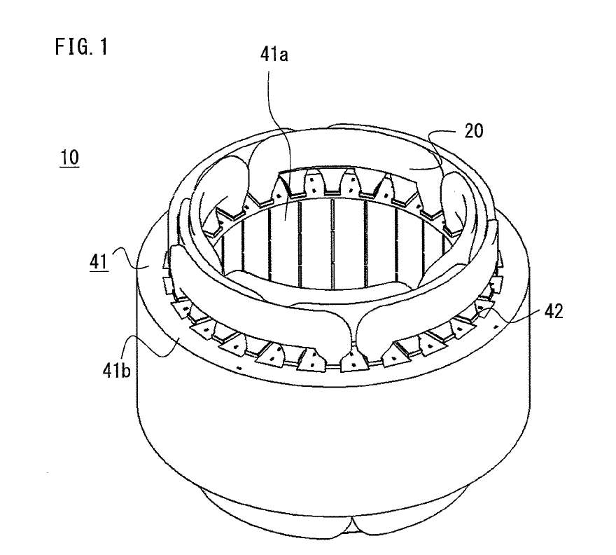

FIG. 1 is a perspective view of an armature 10 of the rotary electric machine.

The armature 10 includes: a stacked iron core 41; a coil 20 mounted to the stacked iron core 41; and a slot cell 42 for electrically insulating the coil 20 and the stacked iron core 41 from each other.

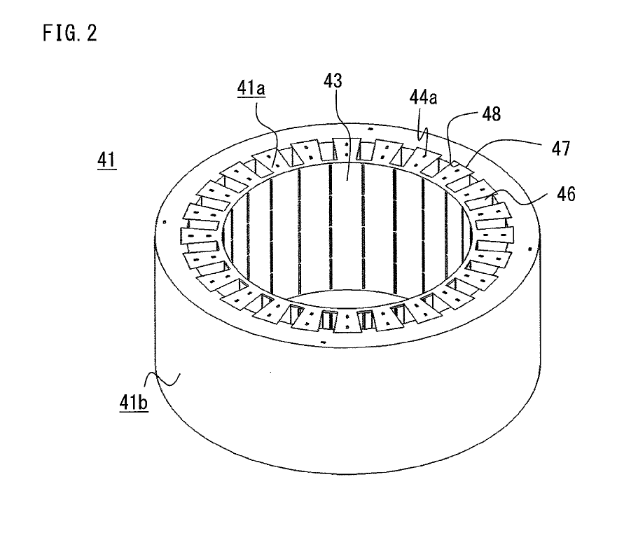

FIG. 2 is a perspective view of the stacked iron core 41.

As shown, the stacked iron core 41 is composed of an inner-side stacked iron core 41a and an outer-side iron core 41b such that teeth divided portions 47 of stacked teeth 43 of the inner-side stacked iron core 41a are pressed into fitting portions 48 of the outer-side iron core 41b from the axial direction. The portion surrounded by stacked teeth 43 that are adjacent to each other of the inner-side stacked iron core 41a, and the inner circumferential surface of the outer-side iron core 41b, is a slot 46 in which the coil 20 is accommodated.

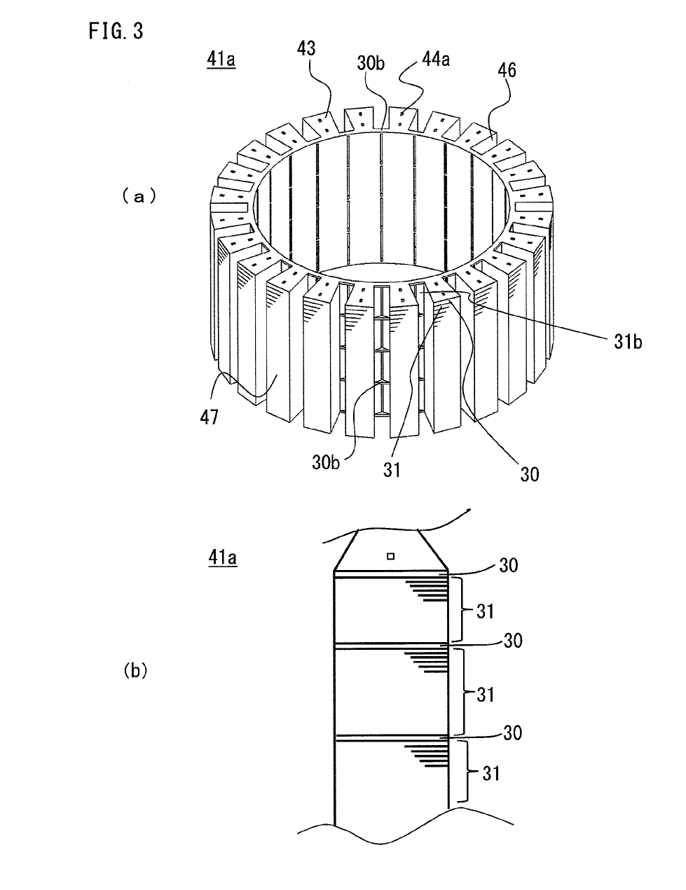

FIG. 3(a) is a perspective view of the inner-side stacked iron core 41a.

FIG. 3(b) is a partially enlarged perspective view of the inner-side stacked iron core 41a.

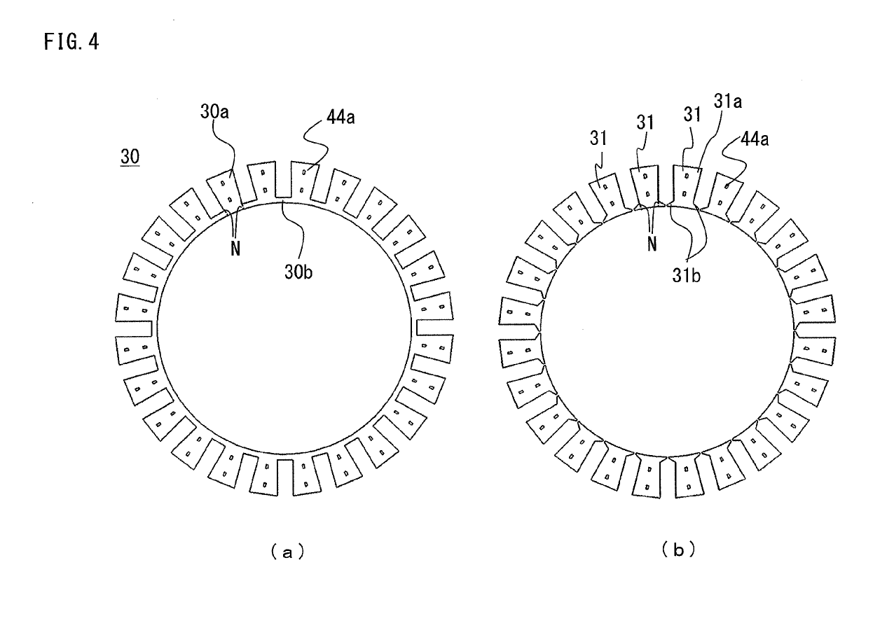

FIG. 4(a) is a plan view of an annular iron core piece 30 forming the same stack-layer in the inner-side stacked iron core 41a.

FIG. 4(b) is a plan view showing the arrangement of a plurality of iron core pieces 31 forming the same stack-layer in the inner-side stacked iron core 41a.

As shown in FIG. 3(b), the inner-side stacked iron core 41a is composed of the iron core pieces 31 and the annular iron core pieces 30 each made of a steel sheet that is a magnetic body.

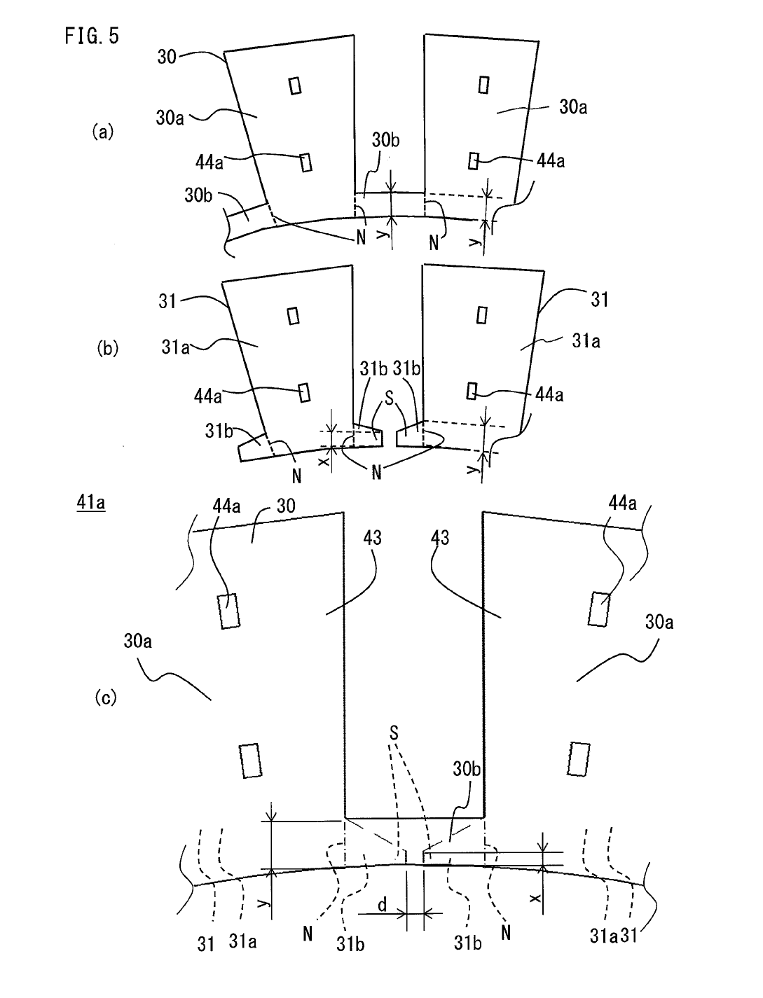

FIG. 5(a) is a partially enlarged plan view of the annular iron core piece 30.

FIG. 5(b) is an enlarged plan view of the iron core piece 31.

FIG. 5(c) is an enlarged plan view of a major part of the inner-side stacked iron core 41a formed by stacking the annular iron core piece 30 and the iron core pieces 31 shown in FIG. 5(a) and FIG. 5(b).

In FIG. 5(c), the annular iron core piece 30 that is depicted by a solid line is stacked at the top. In FIG. 5(c), the portions depicted by broken lines correspond to the iron core pieces 31 that are adjacent to each other and that are stacked under the annular iron core piece 30. The leader lines represented by the broken lines also indicate portions of the iron core piece 31 in the lower layer. Adjacent flange portions 31b are not in contact with each other, and are separated from each other by a predetermined opening width d in the circumferential direction.

As shown in FIG. 4(a) and FIG. 5(a), in the annular iron core piece 30, circumferential both ends N at the inner-circumference-side end of each of a plurality of iron core piece tooth portions 30a (first iron core piece tooth portion) which are radially provided are connected in a ring shape in the circumferential direction by a connecting portion 30b.

Meanwhile, the iron core piece 31 shown in FIG. 4(b) and FIG. 5(b) is composed of: an iron core piece tooth portion 31a (second iron core piece tooth portion) having an identical shape to that of the iron core piece tooth portion 30a of the annular iron core piece 30; and flange portions 31b respectively protruding to both sides in the circumferential direction from the root portion N at the inner-circumference-side end of the iron core piece tooth portion 31a. FIG. 4(b) shows a state where a plurality of the iron core pieces 31 are radially arranged. In the present embodiment, the circumferential both ends N of the iron core piece tooth portion 30a and the root portion N of the iron core piece tooth portion 31a represent the identical site in the stacking direction. The iron core pieces 31 are provided as individual bodies, and are not connected to each other. Each iron core piece tooth portion 30a of the annular iron core piece 30 and each iron core piece 31 are provided with a swage portion 44a.

As shown in FIG. 3(b), on top of each iron core piece tooth portion 30a of the annular iron core piece 30, the iron core piece tooth portion 31a of the corresponding iron core piece 31 is placed, the swage portions 44a thereof are swaged together, and the iron core pieces 31 are stacked by a predetermined plural number. Then, on top of the stacked iron core pieces 31, the annular iron core piece 30 is stacked and swaged again. A series of these stacking steps is repeated, to form the inner-side stacked iron core 41a.

Thus, the inner-side stacked iron core 41a includes a stack-layer composed only of a single annular iron core piece 30, and a stack-layer composed only of a plurality of the iron core pieces 31.

As shown in FIG. 5(a) and FIG. 5(c), the width in the radial direction of the connecting portion 30b of the annular iron core piece 30 is y which is constant in the circumferential direction.

On the other hand, as shown in FIG. 5(b) and FIG. 5(c), the width in the radial direction of the flange portion 31b of the iron core piece 31 is y at the root portion N at the inner-circumference-side end of the iron core piece tooth portion 31a of the iron core piece 31. The width in the radial direction of the flange portion 31b is linearly and gradually reduced from the root portion N toward an end portion S in the circumferential direction, and is x at the end portion S in the circumferential direction. It should be noted that the width in the radial direction of the root portion N of the flange portion 31b is y which is the same as the width in the radial direction of the connecting portion 30b of the annular iron core piece 30. The outer circumferential portion of the flange portion 31b is in a linear shape from the root portion N toward the end portion S.

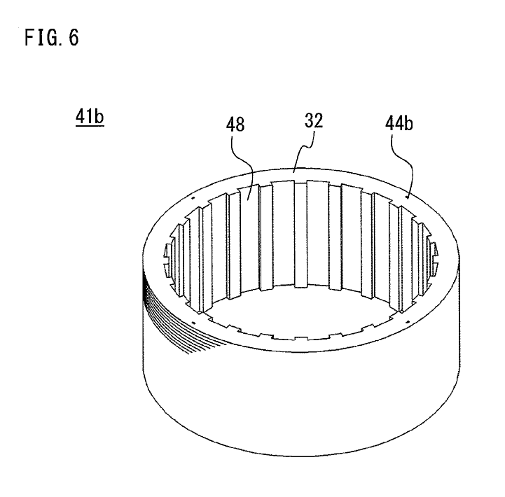

FIG. 6 is a perspective view of the outer-side iron core 41b. The outer-side iron core 41b is composed of annular iron core pieces 32 each made of a steel sheet that is a magnetic body. The annular iron core pieces 32 are stacked in the axial direction and swaged together at a swage portion 44b, whereby the outer-side iron core 41b is formed. The outer-side iron core 41b is fitted to the outer circumference side of the inner-side stacked iron core 41a, thereby serving as an annular yoke portion for magnetically connecting the stacked teeth 43 of the inner-side stacked iron core 41a.

It should be noted that the outer-side iron core 41b is not limited to the outer-side iron core that is formed by stacking a plurality of the annular iron core pieces 32, and may be formed by a single thick annular iron core piece.

The inner circumferential surface of the outer-side iron core 41b is provided with the fitting portions 48 arranged at equal intervals and extending in the axial direction. Then, the teeth divided portions 47 which are the outer circumferential surface of the inner-side stacked iron core 41a are fitted to the fitting portions 48, whereby the teeth divided portions 47 of the inner-side stacked iron core 41a and the fitting portions 48 are magnetically connected to each other.

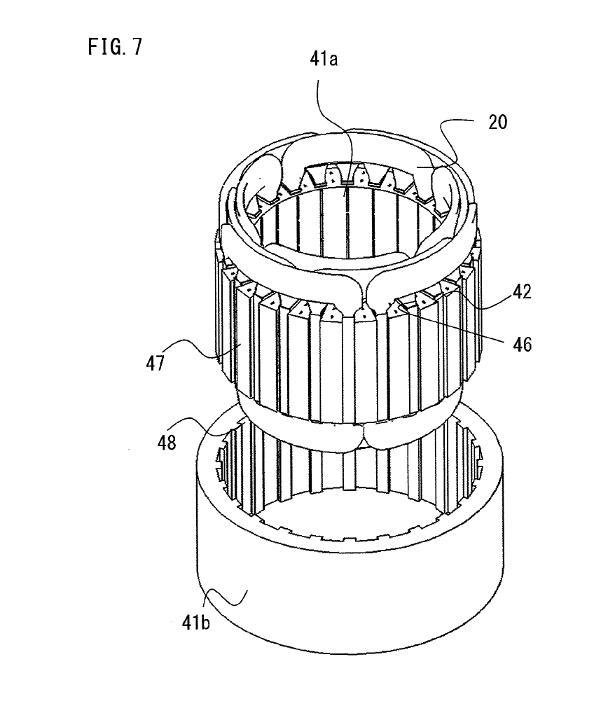

FIG. 7 is a perspective view illustrating an iron core fitting step for fitting, to the outer-side iron core 41b, the inner-side stacked iron core 41a having the coil 20 mounted thereto.

First, into the slots 46 of the inner-side stacked iron core 41a, the coil 20 having the slot cells 42 for insulation attached thereto is inserted. Then, relative to the inner-side stacked iron core 41a, the outer-side iron core 41b is moved in the axial direction. Then, the teeth divided portions 47 of the inner-side stacked iron core 41a and the fitting portions 48 of the outer-side iron core 41b are fitted to each other, whereby the armature 10 shown in FIG. 1 is obtained.

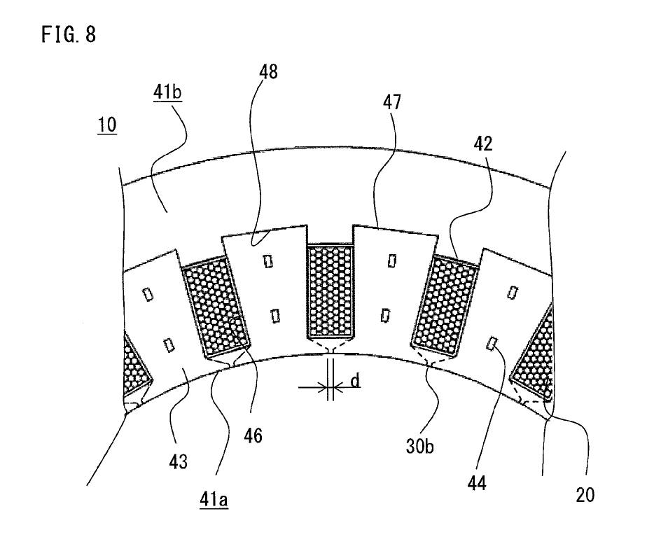

FIG. 8 is a cross-sectional view of a major part of the armature 10. This figure shows the armature 10 cut at the annular iron core piece 30 in a direction perpendicular to the axial direction.

The coil 20 is held in the slots 46 via the slot cells 42. The end portion at the inner circumference side of the coil 20 is held by the connecting portions 30b. With this configuration, it is possible to prevent the coil 20 from protruding from the inside of the slots 46 of the inner-side stacked iron core 41a toward the inner side, and it is possible to cause the coil 20 to be in close contact with the stacked teeth 43 and the outer-side iron core 41b as the annular yoke portion. Accordingly, heat dissipation performance of the armature 10 can be improved.

In addition, the connecting portion 30b has high rigidity because the width y thereof is constant in the radial direction. Accordingly, it is possible to suppress deformation that tends to occur when inserting the coil 20 and when handling the inner-side stacked iron core 41a.

Next, the reason why the width x in the radial direction of the end portion S in the circumferential direction of the flange portion 31b is set to be smaller than the width y in the radial direction of the connecting portion 30b and the root portion N will be described.

In a rotary electric machine provided with a rotor to the inner circumference side of the armature thereof, the magnetic flux that passes the inner circumference side closer to the rotor of the flange portion flows to the rotor. However, the magnetic flux that passes the outer circumference side of the flange portion farther from the rotor becomes leakage flux due to a short distance to an adjacent stacked tooth. Therefore, in the present embodiment, the width x in the radial direction of the end portion S in the circumferential direction of the flange portion 31b is set to be smaller than the width y in the radial direction of the connecting portion 30b and the root portion N, thereby reducing the leakage flux.

Further, with y set to be greater than x in this manner, the section modulus of the connecting portion 30b is increased. Accordingly, it is possible to suppress deformation in the radial direction during manufacture or handling of the inner-side stacked iron core 41a, and it is possible to ensure the quality of the stacked iron core 41.

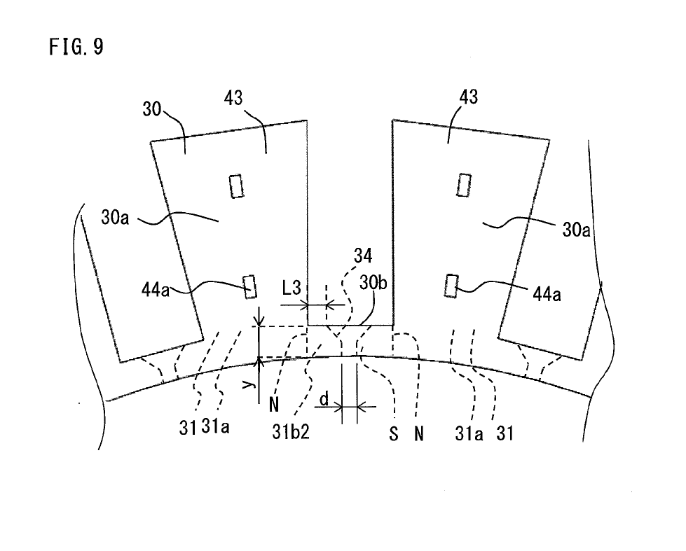

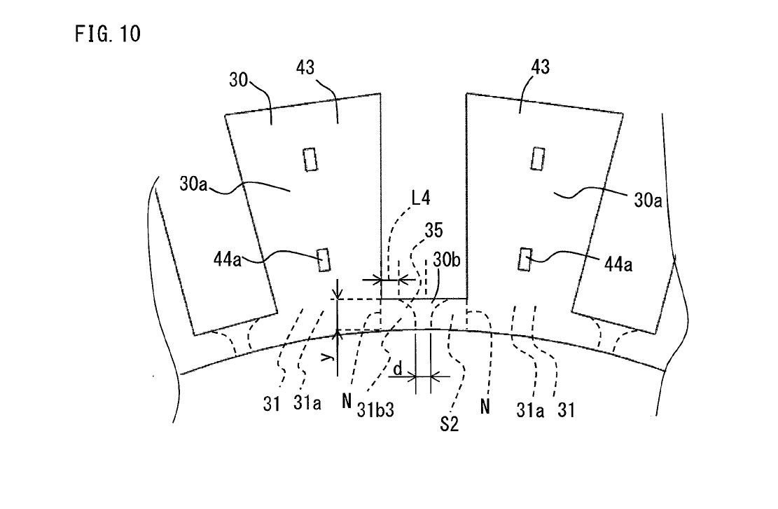

FIG. 9 and FIG. 10 show modifications of the flange portion.

The flange portion 31b described above has a shape in which the width is linearly reduced in the circumferential direction in a plan view such that the width in the radial direction is gradually narrowed from the root portion N to the end portion S in the circumferential direction.

In contrast to this, a flange portion 31b2 shown in FIG. 9 protrudes in the circumferential direction with the same width as the connecting portion 30b at the root portion N, but is provided with a chamfer portion 34 obtained by chamfering the corner at the outer circumference side of the end portion in the circumferential direction.

By being provided with the chamfer portion 34, the flange portion 31b2 has a portion having the width y in the radial direction by a predetermined length L3 in the circumferential direction from the root portion N. Accordingly, rigidity at the root portion N side of the flange portion 31b2 can be improved. Further, magnetic saturation in the root portion N can be reduced, and a high torque can be obtained.

In a flange portion 31b3 shown in FIG. 10, although the root portion N protrudes in the circumferential direction with the same width as the connecting portion 30b, an R-portion 35 is provided that is obtained by providing a fillet to the corner at the outer circumference side of an end portion S2 in the circumferential direction. This flange portion 31b3 also has a portion having the width y in the radial direction by a predetermined length L4 in the circumferential direction from the root portion N. Accordingly, effects similar to those of the flange portion 31b2 can be exhibited, rigidity at the root portion N side of the flange portion 31b3 can be improved, and a high torque can be obtained. Even with the shapes of the flange portions 31b2 and 31a3, effects similar to those of the flange portion 31b can be exhibited.

According to the stacked iron core 41 for armature and the armature 10 according to embodiment 1 of the present invention, in the stacked layer portion other than the stack-layer using the annular iron core piece 30, the iron core pieces 31 forming adjacent stacked teeth 43 are not in contact with each other. In addition, in the flange portion 31b which protrudes in the circumferential direction from the inner-circumference-side end of the stacked tooth 43, the width in the radial direction is reduced from the root portion N toward the end portion S, S2 in the circumferential direction. Thus, leakage flux flowing between the stacked teeth 43 adjacent to each other can be reduced.

With respect to the axial direction of the stacked iron core 41, for every predetermined plural number of stacked layers, the annular iron core piece 30 having the connecting portions 30b for connecting the iron core piece tooth portions 30a is provided. This ensures close contact between the coil 20 and the stacked iron core 41, and prevents the coil 20 from protruding from the slots 46 toward the inner side.

By using the same plate material for the annular iron core piece 30 having the connecting portions 30b and for the iron core piece 31 not having the connecting portion, it is possible to stamp the annular iron core piece 30 and the iron core piece 31 from the same plate material, by means of dies that perform progressive working. Accordingly, the annular iron core piece 30 and the iron core piece 31 can be combined together in the same die in the stacking direction through the stacking and swaging step. Thus, productivity of the stacked iron core for armature and the armature can be improved.

### Embodiment 2

Hereinafter, differences between a stacked iron core for armature and an armature according to embodiment 2 of the present invention, and those according to embodiment 1 will be described with reference to the drawings.

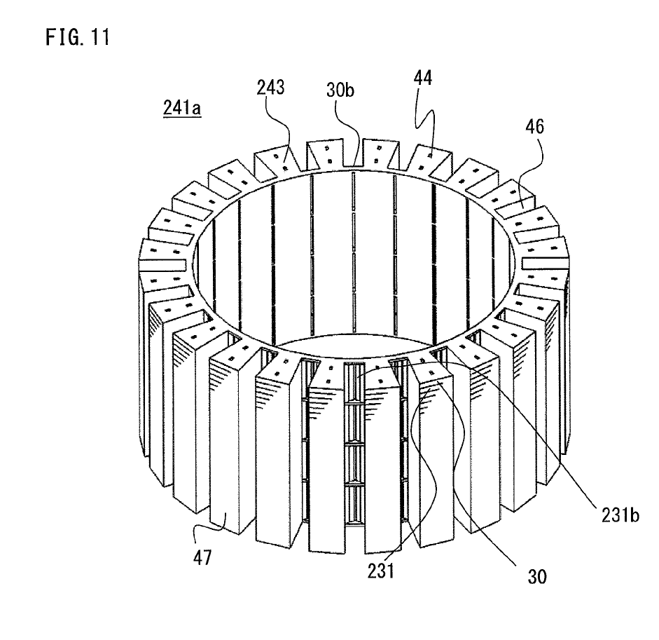

FIG. 11 is a perspective view of an inner-side stacked iron core 241a.

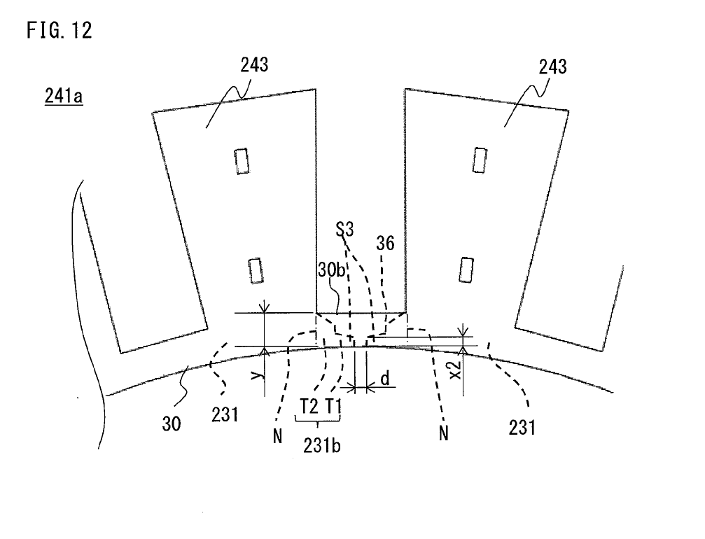

FIG. 12 is an enlarged plan view of a major part of the inner-side stacked iron core 241a.

In the present embodiment, a step portion 36 for sharply reducing the width in the radial direction is provided to the outer circumferential surface of a flange portion 231b of each iron core piece 231. The flange portion 231b is divided into: a thin portion T1 having a small radial-direction width on the circumferential-direction end side of the flange portion 231b; and a thick portion T2 on the root side, with the step portion 36 interposed therebetween. It should be noted that the annular iron core piece 30 is the same as that in embodiment 1. The width y of the connecting portion 30b and the root portion N of the flange portion 231b is adjusted in accordance with the width in the radial direction of the coil 20 such that the connecting portion 30b can hold the inner circumference side of the coil 20. Furthermore, the width y is greater than a width ×2 in the radial direction of an end portion S3 in the circumferential direction of the flange portion 231b.

According to the stacked iron core for armature and the armature according to embodiment 2 of the present invention, the outer circumferential portion of the flange portion 231b has the step portion 36 between the root portion N and the end portion S3 of the flange portion 231b, and the circumferential-direction end side of the flange portion 231b is made still smaller. Thus, during the time of high load when magnetic flux density increases, magnetic flux at the end portion S3 of the thin portion T1 is saturated, and the permeability is reduced. Accordingly, leakage flux is reduced which is caused by magnetic flux at a stacked tooth 243 being transferred to an adjacent stacked tooth 243. Thus, it is possible to increase the maximum output of the rotary electric machine that uses the stacked iron core for armature and the armature according to the present invention.

### Embodiment 3

Hereinafter, differences between a stacked iron core for armature and an armature according to embodiment 3 of the present invention, and those according to embodiment 1 will be described with reference to the drawings.

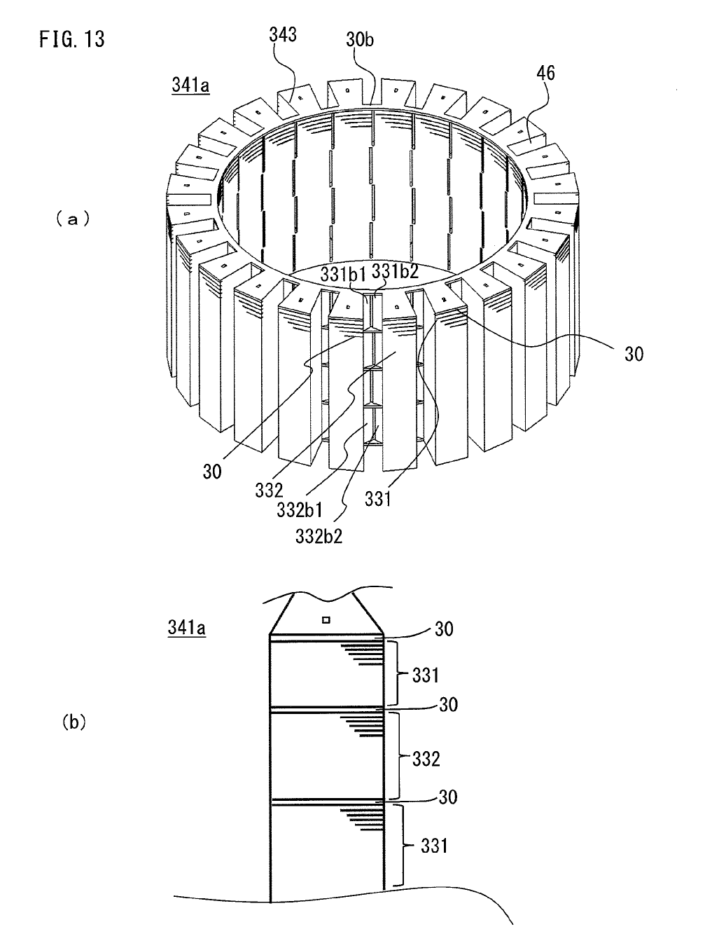

FIG. 13(a) is a perspective view of an inner-side stacked iron core 341a.

FIG. 13(b) is a partially enlarged perspective view of the inner-side stacked iron core 341a.

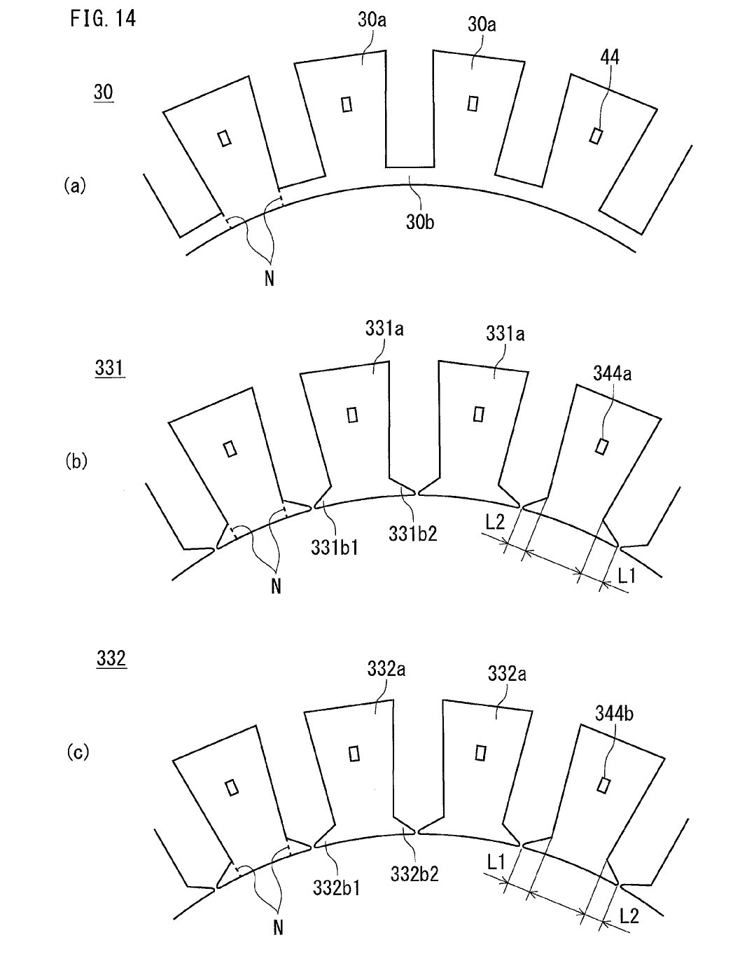

FIG. 14(a) is a plan view of the annular iron core piece 30 forming the same stack-layer in the inner-side stacked iron core 341a.

FIG. 14(b) is a plan view showing the arrangement of a plurality of iron core pieces 331 (first iron core piece) forming the same stack-layer in the inner-side stacked iron core 341a.

The iron core piece 331 has two flange portions 331b1 and 331b2 which respectively protrude in the circumferential direction from the inner-circumference-side end of an iron core piece tooth portion 331a, and the lengths in the circumferential direction of the flange portions 331b1 and 331b2 are different from each other. A length L1 from the root portion N of the flange portion 331b2 is greater than a length L2 from the root portion N of the flange portion 331b1.

As shown in FIG. 14(b), the iron core pieces 331 of the same kind are used for all the iron core pieces that form the same stack-layer.

FIG. 14(c) is a plan view showing the arrangement of a plurality of iron core pieces 332 (second iron core piece) forming the same stack-layer in the inner-side stacked iron core 341a.

The iron core piece 332 has two flange portions 332b1 and 332b2 which respectively protrude in the circumferential direction from the inner-circumference-side end of an iron core piece tooth portion 332a, and the lengths in the circumferential direction of the flange portions 332b1 and 332b2 are different from each other. The length L1 from the root portion N of the flange portion 332b1 is greater than the length L2 from the root portion N of the flange portion 332b2.

As shown in FIG. 14(c), the iron core pieces 332 of the same kind are used for all the iron core pieces that form the same stack-layer.

In this manner, the inner-side stacked iron core 341a includes: a stack-layer composed only of a single annular iron core piece 30; a stack-layer composed only of a plurality of the iron core pieces 331; and a stack-layer composed only of a plurality of the iron core pieces 332.

When either one of the iron core piece 331 and the iron core piece 332 is reversed, the iron core piece 331 and the iron core piece 332 have the same outer shape, with only the protruding direction of the swage portions 344a and 344b different from each other.

Viewed from above the drawing sheets of FIG. 13(a) and FIG. 13(b), in the stack-layer between the top annular iron core piece 30 and the second annular iron core piece 30, the iron core pieces 331 each having the flange portion 331b2 long in the clockwise direction are stacked by a predetermined plural number. In the stack-layer between the second annular iron core piece 30 and the third annular iron core piece 30, the iron core pieces 332 each having the flange portion 332b1 long in the anticlockwise direction are stacked by a predetermined plural number. In this manner, a predetermined plural number of the iron core pieces 331 and a predetermined plural number of the iron core pieces 332 are alternately stacked in stack-layers which are each between the annular iron core pieces 30.

According to the stacked iron core for armature and the armature according to embodiment 3 of the present invention, the iron core pieces 331, 332 which form stacked teeth 343 and which are not connected in the circumferential direction each have two kinds, long and short, of flange portions having different lengths in the circumferential direction. The longer flange portion 332b1, 331b2 of the iron core piece 331 and the iron core piece 332 are present in the opposite directions relative to the circumferential direction, and these are alternately stacked by predetermined plural numbers. Thus, skew effect of suppressing torque pulsation can be exhibited. Accordingly, it is possible to suppress noise and vibration of a rotary electric machine that uses the stacked iron core for armature and the armature according to the present embodiment.

It is noted that, within the scope of the present invention, the above embodiments may be freely combined with each other, or each of the above embodiments may be modified or simplified as appropriate.

1. A stacked iron core for armature comprising:
an outer-side iron core as an annular yoke portion; and
an inner-side stacked iron core having a plurality of stacked teeth fitted in fitting portions provided at an inner circumferential surface of the annular yoke portion, the fitting portions being arranged at equal intervals and extending in an axial direction, the plurality of stacked teeth protruding from the fitting portions to an inner side in a radial direction, wherein
the inner-side stacked iron core includes:
an annular iron core piece having first iron core piece tooth portions, and connecting portions each for connecting, in a ring shape in a circumferential direction, circumferential both ends of an end portion on an inner circumference side of each of adjacent first iron core piece tooth portions; and
an iron core piece stacked between the first iron core piece tooth portions of two of the annular iron core pieces, the iron core piece including: a second iron core piece tooth portion having an identical shape to that of the first iron core piece tooth portion; and flange portions protruding to both sides in a circumferential direction from an inner-circumference-side end of the second iron core piece tooth portion,
the iron core piece is separated from the iron core piece adjacent thereto in the circumferential direction,
the connecting portion has a width y that is constant in the radial direction,
a root portion of the flange portion has the width y in the radial direction, and
an end portion of the flange portion has a width x smaller than y.

2. The stacked iron core for armature according to claim 1, wherein
an outer circumferential portion of the flange portion is in a linear shape from the root portion of the flange portion to the end portion of the flange portion.

3. The stacked iron core for armature according to claim 1, wherein
the flange portion has a portion that has a width y in the radial direction and that extends by a predetermined length from the root portion in the circumferential direction.

4. The stacked iron core for armature according to claim 1, wherein
an outer circumference side at an end of the flange portion has an R-portion having an arc shape.

5. The stacked iron core for armature according to claim 1, wherein
an outer circumferential portion of the flange portion has, between the root portion and the end portion of the flange portion, a step portion for reducing the width in the radial direction of the flange portion.

6. The stacked iron core for armature according to claim 1, wherein
two kinds of the iron core piece exist that are a first iron core piece and a second iron core piece in each of which the two flange portions respectively protruding to both sides in the circumferential direction from the inner-circumference-side end of the second iron core piece tooth portion have different lengths in the circumferential direction,
kinds of the iron core pieces forming the same stack-layer are all the same, and
the second iron core piece has an identical shape to a shape of the first iron core piece that is reversed.

7. The stacked iron core for armature according to claim 6, wherein
the iron core pieces stacked between two of the annular iron core pieces are in a predetermined plural number of layers, and
all the iron core pieces in the predetermined plural number of layers are of either one kind of the first iron core piece or the second iron core piece, and the kind of the iron core pieces and the kind of the iron core pieces stacked with one annular iron core piece interposed therebetween are different from each other.

8. An armature comprising:
a stacked iron core for armature; and
a plurality of coils,
wherein the stacked iron core comprises:
an outer-side iron core as an annular yoke portion; and
an inner-side stacked iron core having a plurality of stacked teeth fitted in fitting portions provided at an inner circumferential surface of the annular yoke portion, the fitting portions being arranged at equal intervals and extending in an axial direction, the plurality of stacked teeth protruding from the fitting portions to an inner side in a radial direction, wherein
the inner-side stacked iron core includes:
an annular iron core piece having first iron core piece tooth portions, and connecting portions each for connecting, in a ring shape in a circumferential direction, circumferential both ends of an end portion on an inner circumference side of each of adjacent first iron core piece tooth portions; and
an iron core piece stacked between the first iron core piece tooth portions of two of the annular iron core pieces, the iron core piece including: a second iron core piece tooth portion having an identical shape to that of the first iron core piece tooth portion; and flange portions protruding to both sides in a circumferential direction from an inner-circumference-side end of the second iron core piece tooth portion,
the iron core piece is separated from the iron core piece adjacent thereto in the circumferential direction,
the connecting portion has a width y that is constant in the radial direction,
a root portion of the flange portion has the width y in the radial direction, and
an end portion of the flange portion has a width x smaller than y,
and wherein
the plurality of coils has insulation coating in slots formed between the inner circumferential surface of the outer-side iron core and adjacent stacked teeth of the inner-side stacked iron core.

9. The stacked iron core for armature according to claim 3, wherein
an outer circumference side at an end of the flange portion has an R-portion having an arc shape.

10. The stacked iron core for armature according to claim 2, wherein
two kinds of the iron core piece exist that are a first iron core piece and a second iron core piece in each of which the two flange portions respectively protruding to both sides in the circumferential direction from the inner-circumference-side end of the second iron core piece tooth portion have different lengths in the circumferential direction,
kinds of the iron core pieces forming the same stack-layer are all the same, and
the second iron core piece has an identical shape to a shape of the first iron core piece that is reversed.

11. The stacked iron core for armature according to claim 3, wherein
two kinds of the iron core piece exist that are a first iron core piece and a second iron core piece in each of which the two flange portions respectively protruding to both sides in the circumferential direction from the inner-circumference-side end of the second iron core piece tooth portion have different lengths in the circumferential direction,
kinds of the iron core pieces forming the same stack-layer are all the same, and
the second iron core piece has an identical shape to a shape of the first iron core piece that is reversed.

12. The stacked iron core for armature according to claim 4, wherein
two kinds of the iron core piece exist that are a first iron core piece and a second iron core piece in each of which the two flange portions respectively protruding to both sides in the circumferential direction from the inner-circumference-side end of the second iron core piece tooth portion have different lengths in the circumferential direction,
kinds of the iron core pieces forming the same stack-layer are all the same, and
the second iron core piece has an identical shape to a shape of the first iron core piece that is reversed.

13. The stacked iron core for armature according to claim 5, wherein
two kinds of the iron core piece exist that are a first iron core piece and a second iron core piece in each of which the two flange portions respectively protruding to both sides in the circumferential direction from the inner-circumference-side end of the second iron core piece tooth portion have different lengths in the circumferential direction,
kinds of the iron core pieces forming the same stack-layer are all the same, and
the second iron core piece has an identical shape to a shape of the first iron core piece that is reversed.

14. The stacked iron core for armature according to claim 9, wherein
two kinds of the iron core piece exist that are a first iron core piece and a second iron core piece in each of which the two flange portions respectively protruding to both sides in the circumferential direction from the inner-circumference-side end of the second iron core piece tooth portion have different lengths in the circumferential direction,
kinds of the iron core pieces forming the same stack-layer are all the same, and
the second iron core piece has an identical shape to a shape of the first iron core piece that is reversed.

15. The stacked iron core for armature according to claim 10, wherein
the iron core pieces stacked between two of the annular iron core pieces are in a predetermined plural number of layers, and
all the iron core pieces in the predetermined plural number of layers are of either one kind of the first iron core piece or the second iron core piece, and the kind of the iron core pieces and the kind of the iron core pieces stacked with one annular iron core piece interposed therebetween are different from each other.

16. The stacked iron core for armature according to claim 11, wherein
the iron core pieces stacked between two of the annular iron core pieces are in a predetermined plural number of layers, and
all the iron core pieces in the predetermined plural number of layers are of either one kind of the first iron core piece or the second iron core piece, and the kind of the iron core pieces and the kind of the iron core pieces stacked with one annular iron core piece interposed therebetween are different from each other.
